(19) United States
(12) Patent Application Publication
(10) Pub. No.: US 2025/0217293 A1
(43) Pub. Date: Jul. 3, 2025

(54) Shared Last Level Cache Usage Management for Multiple Clients

(71) Applicant: Advanced Micro Devices, Inc., Santa Clara, CA (US)

(72) Inventors: Indrani Paul, Austin, TX (US); Benjamin Tsien, Fremont, CA (US); Mahesh Subramony, Austin, TX (US); Oleksandr Khodorkovsky, Austin, TX (US)

(73) Assignee: Advanced Micro Devices, Inc., Santa Clara, CA (US)

(21) Appl. No.: 18/989,911

(22) Filed: Dec. 20, 2024

Related U.S. Application Data
(60) Provisional application No. 63/617,240, filed on Jan. 3, 2024.

(51) Int. Cl. G06F 12/084

(52) U.S. Cl. CPC G06F 12/084

(57) ABSTRACT

Shared last level cache usage management for multiple clients is described. In one or more implementations, a system includes a shared last level cache coupled to multiple clients and a dynamic random access memory. The system further includes a linear dropout regulator that supplies power to the shared last level cache. A data fabric included in the system is configured to control a level of the power supplied from the linear dropout regulator to be either a first level or a second level based on usage of the shared last level cache.

### RELATED APPLICATION

This application claims priority under 35 U.S.C. § 119(e) to U.S. Provisional Patent Application No. 63/617,240, filed Jan. 3, 2024, the entire content of which is hereby incorporated by reference.

### BACKGROUND

Various computing systems include a main, last-level cache that is attached to a central processing unit (CPU) and located before the systems' dynamic random access memory (DRAM). In addition to a main cache, these systems often have another cache, called a shared last level cache. The shared last level cache is a system level cache that is coupled to the main cache and the DRAM, and is available to multiple clients, not just the CPU. When any of these clients use the shared last level cache instead of a high-power DRAM, their memory accesses occur quicker and consume less power.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system that implements shared last level cache usage management for multiple clients.

FIG. 3 depicts a non-limiting example of data records maintained by components of an example system that implements shared last level cache usage management for multiple clients.

FIG. 4 depicts a state diagram of different operating states of a non-limiting example system that implements shared last level cache usage management for multiple clients.

FIG. 5 depicts a procedure for performing shared last level cache usage management for multiple clients.

### DETAILED DESCRIPTION

A system, such as a system on chip (SoC), often includes multiple clients. In addition to a Central Processing Unit (CPU), non-limiting examples of these system clients include an Audio Co-Processor (ACP), an Intelligent Processing Unit (IPU), a Graphics Processing Unit (GPU), and the like. The different clients execute specialized workloads or operations that enable the system to perform functions.

To improve performance of workloads involving memory accesses, it is common for a CPU to have its own main, last-level cache. Accessing the main cache allows the CPU to avoid high power and latency penalties otherwise incurred from accessing a dynamic random access memory (DRAM). Other system clients do not typically have access to a main cache, and instead rely on a shared system cache called a shared last level cache. In a memory hierarchy of the system, the shared last level cache is located after a main last-level cache, but before a DRAM subsystem. Memory accesses that go through the shared last level cache help clients without their own main last level cache to avoid DRAM penalties and improve performance.

A shared last level cache is powered by a voltage plane, which is controlled using a linear dropout regulator or other power circuit. On power-up, the shared last level cache undergoes an initialization process, which takes time and electrical energy to redistribute fuses and warm up the memory. To reduce latency with utilizing the shared last level cache, the shared last level cache is kept powered-on and active, even when not being used. When the shared last level cache is active, the linear dropout regulator consumes power and overhead. Keeping the shared last level cache powered-on all the time wastes energy. Even though a shared last level cache has potential to reduce latent, high power DRAM accesses, simply having a shared last level cache does not alone prevent power from being wasted. As one example, power is often wasted by the system to keep shared last level cache circuitry active even though no client is actively using the shared last level cache.

Performance benefits attributed to shared last level cache usage are dependent on the type of workloads performed in the system. Many workloads do not involve accesses to the shared last level cache. For example, with a CPU that already has access to a main cache, which is larger or the same size as the shared last level cache, utilization of the shared last level cache instead of the main cache increases latency and consumes more power keeping an unused shared last level cache powered-on. Many other workloads rely on the shared last level cache, but their shared last level cache usage is intermittent around brief periods of idleness. For instance, with a different client (e.g., APU, IPU, GPU) that does not have a large main cache, utilization of the shared last level cache enables the client to consume less power than if its accesses went to the DRAM. However, when the client is idle (e.g., not accessing the shared last level cache), the system power expended to maintain the shared last level cache in an active, accessible or usable state (e.g., to be operable to fetch and store) is wasted.

Shared last level cache usage management for multiple clients is described. In accordance with the described techniques, a system includes a shared last level cache shared by multiple clients. To ensure that the shared last level cache does not hinder, but rather improves performance and power conservation within the system, a power management policy is implemented. Execution of the power management policy enables the system to carefully control when the shared last level cache is powered-on, powered-off, or otherwise maintained in a power-saving retention mode during brief periods of being idle with respect to client usage.

In one or more implementations, a power management firmware executes in a system with a shared last level cache. The power management firmware maintains a client record of each of clients in the system that have access to the shared last level cache, including to keep track of whether the shared last level cache is useful (e.g., presently) to each client. In at least one example, the shared last level cache is useful to a client if that client does not have access to a main last level cache of its own. In various aspects, the shared last level cache is useful to a client if that client communicates to the power management firmware that the client wants to make use of the shared last level cache. In at least one implementation, the shared last level cache is useful to a client if that client has a contiguous memory access pattern.

When the power management firmware determines that shared last level cache is not useful to any of the clients, the power management firmware causes the system to flush cache content and turn-off the shared last level cache. Turning off the shared last level cache deactivates the linear dropout regulator and other shared last level cache circuitry to save power. If there is at least one client that possibly benefits from the shared last level cache being active, the power management firmware does not turn-off the shared last level cache. Later, when the power management firmware determines that shared last level cache is presently useful to at least one of the clients, the power management firmware causes the system to turn-on the shared last level cache. The shared last level cache does not turn-on immediately, however. A latency penalty is introduced in the system when the shared last level cache is activated to allow sufficient time for the linear drop out regulator to ramp voltage to operating level, the shared last level cache circuitry to redistribute fuses and initialize tags, and the client accesses to warm up the cache to its access patterns.

As indicated above, keeping the shared last level cache powered-on all the time to reduce latency incurred from shared last level cache reinitialization carries a heavy power penalty and wastes energy. To enable finer control over the shared last level cache, the system includes a data fabric that communicates with the power management firmware.

With a focus on minimizing latency in memory accesses, the data fabric determines whether to route client memory accesses to either the shared last level cache or the DRAM. In addition, the data fabric maintains a status record of each of the clients in the system that presently share access to the shared last level cache. The status record helps the data fabric keep track of whether any clients are active clients, which means actively using the shared last level cache (e.g., to access cache content, to load and store cache data). For example, the status record indicates when a client has data stored in the shared last level cache, and whether that client is presently accessing the shared last level cache or whether the client is idle with respect to shared last level cache accesses. If presently accessing the cache content, the client is active. If not presently accessing the cache content (e.g., for a measured period of time), the client is inactive, or not active. In addition, to indicating the active clients, the status record indicates how each active client is using the shared last level cache. Specifically, the status record helps the data fabric to identify whether a client uses the shared last level cache as a standard cache or a Cache-As-RAM (CAR). When a client uses the shared last level cache as a standard cache, data entries in the shared last level cache are occasionally evicted into DRAM (e.g., based on a cache replacement policy). When a client utilizes the shared last level cache as a CAR, a fixed allocation of shared last level cache memory is allocated to the client such that data remains accessible from the shared last level cache and is not evicted out to DRAM.

To balance latency and power consumption of the shared last level cache, the data fabric tracks when the shared last level cache is idle. During periods of idle time when none of the active clients are presently accessing their data in the shared last level cache, the data fabric causes the shared last level cache to operate in a retention mode. In the retention mode, the data fabric directs the linear dropout regulator to supply a retention voltage to the shared last level cache, which is less than a voltage (e.g., a normal voltage) supplied to the shared last level cache when clients are active. The retention voltage is sufficient to maintain fuse distributions within the shared last level cache, as well as cache content and other initialization parameters. Time is saved by no reinitialization being performed to cause the shared last level cache to return to a usable state when an active client requests access again.

Reducing the supply voltage to the shared last level cache in retention mode saves power even though the linear dropout regulator remains powered-on. More energy is consumed during retention mode than when the shared last level cache and the linear dropout regulator are completely powered-off by the power management firmware (e.g., when no clients might use the shared last level cache). However, the system consumes less power overall than if during idle periods the shared last level cache is kept fully active and powered-on. A further benefit of retention mode is that much of the latency attributed to reactivating the shared last level cache is avoided. Upon transitioning out of retention mode, the linear dropout regulator is redirected by the data fabric to supply a normal voltage to the shared last level cache. Because the retention voltage preserves fuse distributions within the shared last level cache, as well as cache content and other initialization parameters in the shared last level cache, reinitialization of the shared last level cache is avoided after leaving the retention mode. Shared last level cache performance is maintained using less time and energy than re-initialization. By implementing a power management scheme for the shared last level cache in this way, energy is saved during idle periods and performance is maintained to enable clients to make quick use of the shared last level cache when the clients become active again.

In some aspects, the techniques described herein relate to a system including: a shared last level cache coupled to multiple clients and a dynamic random access memory, a linear dropout regulator that supplies power to the shared last level cache, and a data fabric that controls a level of the power supplied from the linear dropout regulator based on usage of the shared last level cache.

In some aspects, the techniques described herein relate to a system, wherein the data fabric is configured to control the level of the power supplied from the linear dropout regulator to be either a first level that enables at least one active client to use the shared last level cache or a second level to keep the shared last level cache in a ready state when the at least one active client does not use the shared last level cache.

In some aspects, the techniques described herein relate to a system, further including: a side-band connection between the linear dropout regulator and the data fabric, wherein the data fabric controls the level of the power supplied from the linear dropout regulator by sending a signal over the side-band connection to cause the linear dropout regulator to supply power for the shared last level cache at either the first level or the second level.

In some aspects, the techniques described herein relate to a system, wherein the first level includes a normal voltage level and the second level includes a retention voltage level that is less than the normal voltage level.

In some aspects, the techniques described herein relate to a system, further including: at least one processor configured to execute power management firmware that: turns the linear dropout regulator on to supply the power at the first level to initialize the shared last level cache and enable the at least one active client to use the shared last level cache, and turns the linear dropout regulator off to supply the power at a third level that is lower than the second level when none of the multiple clients is active.

In some aspects, the techniques described herein relate to a system, wherein the third level includes an approximately zero-voltage level.

In some aspects, the techniques described herein relate to a system, wherein the system is configured to operate in at least three different states, wherein: during a first state, the power management firmware causes the shared last level cache to be powered-off, during a second state, the power management firmware causes the shared last level cache to be powered-on, and during a third state, the data fabric causes the shared last level cache to operate in retention mode where, based on the power supplied for the shared last level cache at the second level, the shared last level cache remains initialized to be ready to handle future accesses upon later transitioning back to the second state.

In some aspects, the techniques described herein relate to a system, wherein the system transitions from the first state to the second state when at least one of the multiple clients becomes active.

In some aspects, the techniques described herein relate to a system, wherein the system transitions from the second state to the third state during an idle period of the data fabric when the at least one active client is not using the shared last level cache.

In some aspects, the techniques described herein relate to a system, wherein after transitioning to the third state the shared last level cache maintains cache content stored in the shared last level cache during the second state.

In some aspects, the techniques described herein relate to a system, wherein after transitioning to the third state the shared last level cache maintains fuse distributions previously established for the shared last level cache during the second state.

In some aspects, the techniques described herein relate to a system, wherein when none of the multiple clients is active the system transitions from the second state to the first state or from the third state to the second state to the third state.

In some aspects, the techniques described herein relate to a system, wherein the multiple clients include a central processing unit, wherein the system further includes a main cache internal to the central processing unit, and the shared last level cache is coupled to the main cache and the dynamic random access memory.

In some aspects, the techniques described herein relate to a data fabric including hardware components configured to: switch a level of power supplied to a shared last level cache to be at a first level that enables multiple active clients to use the shared last level cache, switch the level of power to be at a second level that keeps the shared last level cache in a ready state when each of the active clients is idle with respect to use of the shared last level cache, and switch the level of power to be at the first level when at least one of the active clients is no longer idle with respect to use of the shared last level cache.

In some aspects, the techniques described herein relate to a method including: enabling, by a data fabric of a system, an active client to fulfill accesses using a shared last level cache instead of a dynamic random access memory, controlling, by the data fabric, a linear dropout regulator to switch a level of power supplied to the shared last level cache to be at a first level, based on the active client being idle with respect to use of the shared last level cache, and controlling, by the data fabric, the linear dropout regulator to switch the level of power to be at a second level when the active client is no longer idle with respect to use of the shared last level cache.

In some aspects, the techniques described herein relate to a method, further including: executing, by a processor of the system, power management firmware to identify a workload of the active client that benefits from access to the shared last level cache instead of the dynamic random access memory, and communicating the active client to the data fabric to cause the data fabric to enable the active client to fulfill accesses at the shared last level cache.

In some aspects, the techniques described herein relate to a method, further including: controlling, via the power management firmware, the linear dropout regulator to switch the level of the power supplied to the shared last level cache to be at a third level that is lower than the second level to power off the shared last level cache when no active clients are available to use the shared last level cache, and controlling, via the power management firmware, the linear dropout regulator to switch the level of the power supplied to the shared last level cache to transition from the third level to the first level for enabling the active client to use the shared last level cache.

In some aspects, the techniques described herein relate to a method, wherein controlling the linear dropout regulator by the data fabric includes: sending, by the data fabric, a signal over a side-band connection between the linear dropout regulator and the data fabric, whether the linear dropout regulator is to supply power at the first level or the second level.

In some aspects, the techniques described herein relate to a method, wherein controlling the linear dropout regulator to switch the level of power to be at the second level includes maintaining cache content in the shared last level cache.

In some aspects, the techniques described herein relate to a method, further including: controlling, by the data fabric, the linear dropout regulator to switch the level of power to be at the second level for maintaining the cache content and fuse distributions previously established for the shared last level cache.

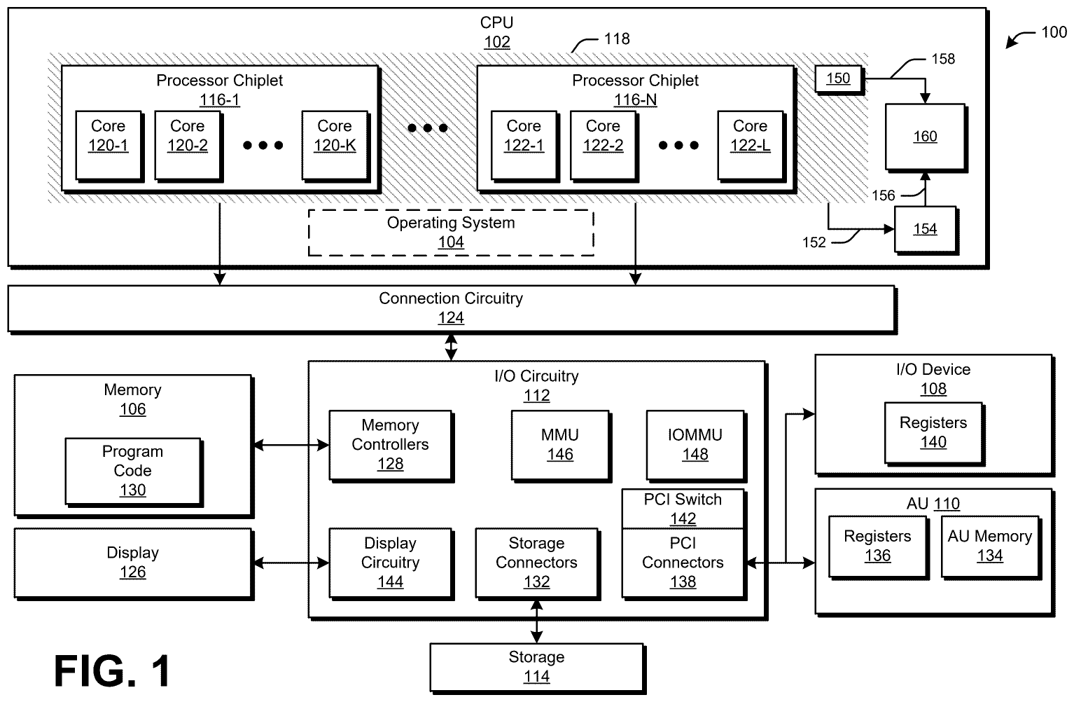

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as “threads,” for an application. By way of example, the processor chiplets 116 and/or the processor cores 120, 122 are examples of computing clients of the processing system 100. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (516-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

In this example, a shared last level cache controller 150 is implemented in the CPU 102, and communicatively coupled via a side-band connection 152 with the data fabric 118 and a linear dropout regulator 154. The shared last level cache controller 150 is further communicatively coupled via one or more interconnects or links 158 with the data fabric 118 and a shared last level cache 160 implemented in the CPU 102. A voltage plane 156 powers the shared last level cache 160 from the linear dropout regulator 154. In variations, however, one or more of the shared last level cache controller 150, the sideband connection 152, the linear dropout regulator 154, the voltage plane 156, the links 158, and the shared last level cache 160 are external to the CPU 102 or included in and/or are implemented by one or more other components of the processing system 100, such as the memory 106, the I/O device 108, the AU 110, the I/O circuitry 112, the storage 114, and so forth. In at least one implementation, the shared last level cache controller 150, the sideband connection 152, the linear dropout regulator 154, the voltage plane 156, the links 158, and the shared last level cache 160 are included in at least two of the depicted components of the processing system 100. By way of example, one or more of the shared last level cache controller 150, the sideband connection 152, the linear dropout regulator 154, the voltage plane 156, the links 158, and the shared last level cache 160 are included in or otherwise implemented by at least the CPU 102 and the AU 110.

Examples of connections which are usable to implement the data fabric 118 include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. These memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 128 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCle connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The 100 is configurable in a variety of ways with different combinations of components in accordance with the described techniques.

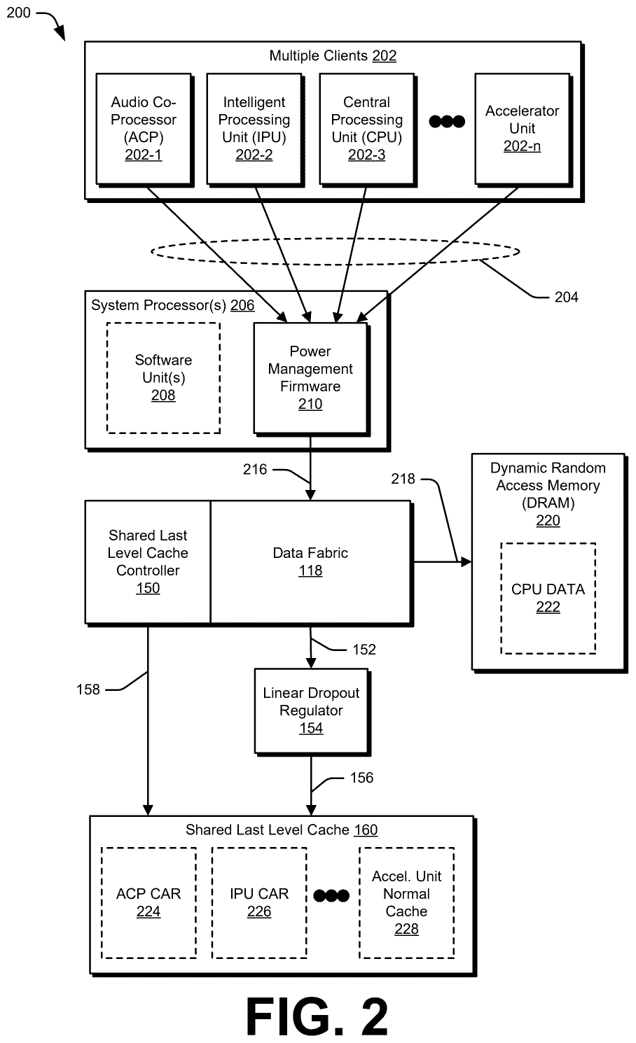

FIG. 2 is a block diagram of a non-limiting example system 200 that implements shared last level cache usage management for multiple clients. It is to be appreciated that in variations, the system 200 and the individual components illustrated therein include more, fewer, and/or different hardware components without departing from the spirit or scope of the described techniques, e.g., further caches, semiconductor infrastructure processing (IP) cores, networking interfaces, other controllers, memory, accelerator cores, etc. The system 200 is an example of the processing system 100.

Examples of devices or apparatuses in which the system 200 is implemented include, but are not limited to, one or more server computers, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

In accordance with the described techniques, the system 200 includes multiple clients 202, which include any number of individual clients. As various non-limiting examples of the clients 202, FIG. 2 depicts the system 200 as having an ACP 202-1, an IPU 202-2, a CPU 202-3 (which is an example of the CPU 102), and an accelerator unit 202-n (which is an example of the AU 110 or a GPU). Each of the clients 202 performs various types of workloads. One or more of the clients 202 (e.g., the CPU 202-3) handle workloads that benefit from accessing their own internal cache. At least one of the clients 202 (e.g., the ACP 202-1, the IPU 202-2, the accelerator unit 202-n), however, does not have a dedicated main cache and relies on a system cache for improved memory access performance. In at least one implementation, the clients 202 include chiplets, such as the processor chiplets 116-1 through 116-N, including infrastructure processing blocks, the processor cores 120-1 through 120-k and 122-1 through 122-k, or other hardware components that form electrical circuits configured to execute (e.g., concurrently) one or more series of instructions, also referred to herein as “threads,” for an application.

A shared system cache, which is available to each of the clients 202, is depicted in FIG. 2 as the shared last level cache 160. In a memory hierarchy of the system 200, the shared last level cache 160 is coupled to the clients 202 (including any main client cache) and a DRAM 220 (e.g., of the memory 106). The shared last level cache 160 is located closer to the clients 202 than the clients 202 are to the DRAM 220. In at least one example, the shared last level cache 160 is a hardware component that forms an electrical circuit configured to store data (e.g., at least temporarily) so that a future request for the data is served faster from the shared last level cache 160 than from the DRAM 220.

Although depicted and described throughout as DRAM, the DRAM 220 in one or more aspects includes other types of random-access memory in the system 200. The DRAM 220 or other type of main memory in at least one implementation includes at least one of a higher-level cache than the shared last level cache 160, or secondary storage, such as the storage 114 (e.g., a mass storage device) or removable media (e.g., flash drives, memory cards, compact discs, and digital video disc). In one or more implementations, the shared last level cache 160 is at least one of smaller than the DRAM 220, faster at serving data to the clients 202 than the DRAM 220, or more energy efficient at serving data to the clients 202 than the DRAM 220. It is to be appreciated that in various implementations the shared last level cache 160 has additional or different characteristics which make serving data to the clients 202 advantageous over serving such data from the DRAM 220. In at least one example, the DRAM 220 is a hardware component that forms an electrical circuit configured to store data (e.g., at least temporarily) so that a future request for the data is served faster from the DRAM 220 than from other data sources of the system 200, such as disks, storage arrays, etc., which are not shown for simplicity of the drawings.

Data management within the shared last level cache 160 is controlled by the shared last level cache controller 150. The shared last level cache controller 150 is a hardware component that implements an electronic circuit configured to manage the retrieval, storage, and delivery of data at the shared last level cache 160. The shared last level cache controller 150 shares one or more interconnects or links 158 with the shared last level cache 160. The links 158 transfer data to and from the shared last level cache 160. The shared last level cache controller 150 manages the retrieval, storage, and delivery of data to and from the shared last level cache 160 by exchanging signals on the links 158. The shared last level cache controller 150 determines whether to send client data out to the shared last level cache 160, or whether to route the client data stored in the shared last level cache 160 out to the DRAM 220. In one or more examples, the shared last level cache controller 150 determines where to store new data, when to fetch additional data from adjacent addresses to be ready in case the clients 202 request the data soon after, and, if the shared last level cache 160 is full, what old data to flush from the shared last level cache 160 out into the DRAM 220. In at least one implementation, software (e.g., firmware) executes on the hardware of the shared last level cache controller 150. Whether implemented in hardware or with a combination of hardware and software, the shared last level cache controller 150 is configured to improve performance of the shared last level cache 160. As one example, the shared last level cache controller 150 maintains a table of addresses associated with data already stored in the shared last level cache 160. The shared last level cache controller 150 checks the table to determine if one of the clients 202 is referencing data that is already present in memory of the shared last level cache 160.

Data routing between the clients 202 and the shared last level cache 160 and/or between the clients 202 and the DRAM 220 is handled by the data fabric 118 (e.g., a data fabric device), which is depicted in the system 200 as being collocated to the shared last level cache controller 150. The data fabric 118 represents hardware (e.g., an electrical circuit) that implements connections between the clients 202 and the shared last level cache 160 and/or between the clients 202 and the DRAM 220. Examples of connections which are usable to implement the data fabric 118 include but are not limited to, buses (e.g., a data bus, a system, an address bus), interconnects, memory channels, through silicon vias, traces, and planes. Other example connections include optical connections, fiber optic connections, and/or connections or links based on quantum entanglement. In one or more aspects, the data fabric 118 includes embedded logic or hardware components that enable the correct routing of data through these connections.

The data fabric 118 routes client data that is suitable for the shared last level cache 160 through the shared last level cache controller 150 and out to the shared last level cache 160. The data fabric 118 routes client data that is not suitable for the shared last level cache 160 out to the DRAM 220. For example, when portions of the shared last level cache 160 are flushed, the data fabric 118 routes client data retrieved by the shared last level cache controller 150 from the shared last level cache 160 out to the DRAM 220.

With a focus on minimizing latency in memory accesses, the data fabric 118 routes memory accesses by the clients 202 either to the shared last level cache 160 or to the DRAM 220. In at least one implementation, hardware and/or software executing on the hardware of the data fabric 118 maintains a status record of each of the clients 202 that presently share access to the shared last level cache 160. Each of the clients 202 that is using the shared last level cache 160 (e.g., accessing to fetch and store client instructions and data) is an active client. The status record helps the data fabric 118 keep track of whether any of the clients 202 are active clients that are actively using the shared last level cache 160, or otherwise, whether any of the previously active clients 202 is idle with respect to using (e.g., accessing) the shared last level cache 160. For example, the status record indicates when one of the clients 202 has data stored in the shared last level cache 160, and whether that client is presently accessing the shared last level cache 160 or whether the client is idle with respect to the data stored in the shared last level cache 160. In addition, the status record indicates how each of the clients 202 is using the shared last level cache 160. Specifically, the status record helps the data fabric 118 to identify whether any of the clients 202 uses the shared last level cache 160 as a standard cache, or instead, as a CAR. When one of the clients 202 uses the shared last level cache 160 as a standard cache, data entries in the shared last level cache 160 are occasionally evicted into the DRAM 220 (e.g., based on a cache replacement policy implemented by the shared last level cache controller 150). When one of the clients 202 utilizes the shared last level cache 160 as a CAR, a fixed allocation of storage in the shared last level cache 160 is allocated to the client such that data remains accessible from the shared last level cache 160 and is not evicted out to the DRAM 220.

The system 200 also includes one or more system processors 206, which are electronic circuits that perform various operations to facilitate memory accesses within the system 200. Examples of the system processors 206 include a CPU, a GPU, a field programmable gate array (FPGA), an accelerator, an accelerated processing unit (APU), and a digital signal processor (DSP), to name a few. In one or more variations, the system processors 206 include a single processor core. In other variations, the system processors 206 include multiple cores. The system processors 206 are individual processing units that read and execute instructions (e.g., of a program), examples of which include to add, to move data, and to branch. As depicted in FIG. 2, the system processors 206 execute instructions associated with programs depicted as one or more optional software units 208, and a power management firmware 210. In at least one implementation, the clients 202 are integrated within one or more of the system processors 206. For example, the clients 202 represent the chiplets 116 or cores 120 of the CPU 102, which execute specific functions on portions of dedicated hardware to implement the system processors 206.

The power management firmware 210 represents software that executes on the system processors 206 to maintain a client record of each of the clients 202 in the system 200 that have access to the shared last level cache 160. In addition, the power management firmware 210 keeps track of whether the shared last level cache 160 is presently useful to each of the clients 202. For example, as each of the clients 202 make memory requests, the power management firmware 210 determines whether caching through the shared last level cache 160 will benefit that client or not. The power management firmware 210 powers the shared last level cache 160 on-demand based on whether routing traffic to the shared last level cache 160 is presently useful or not. The power management firmware 210, in one or more implementations, defines when to configure the shared last level cache 160 to be powered-on and running in an active state, and when to save power by shutting the shared last level cache 160 off.

For example, consider a case where only one of the clients 202 is active, such as the CPU 202-3. In response to a memory request from the CPU 202-3, the power management firmware 210 indicates that the shared last level cache 160 is not helpful (e.g., because the CPU 202-3 has a main cache internal to the CPU 202-3, and the shared last level cache 160 is located further from the CPU 202-3 than the main cache). The power management firmware 210 refrains from turning-on the shared last level cache 160 and keeps the shared last level cache 160 in a powered-off state. Memory accesses that are not handled by the main cache of the CPU 202-3 are directed through the data fabric 118 to the DRAM 220. As depicted in FIG. 2, the DRAM 220 optionally stores information associated with the CPU 202-3 as CPU data 222.

As another example, assume the ACP 202-1, the IPU 202-2, and the accelerator unit 202-n are active. In response to memory requests from these active clients 202, the power management firmware 210 indicates that the shared last level cache 160 is helpful (e.g., because unlike the CPU 202-3, each of the ACP 202-1, the IPU 202-2, and the accelerator unit 202-n have no internal cache). The power management firmware 210 turns-on the shared last level cache 160 and keeps the shared last level cache 160 in a powered-on state. Memory accesses from the ACP 202-1, the IPU 202-2, and the accelerator unit 202-n are directed through the data fabric 118 to the shared last level cache 160. As depicted in FIG. 2, the shared last level cache 160 optionally stores information associated with the ACP 202-1, the IPU 202-2, and the accelerator unit 202-n. The ACP 202-1 and the IPU 202-2 use the shared last level cache 160 to provide each a respective CAR, which are depicted in FIG. 2 as ACP CAR 224 and IPU CAR 226, respectively. The accelerator unit 202-n uses the shared last level cache 160 to provide a standard cache, which is depicted in FIG. 2 as an accelerator unit normal cache 228.

The clients 202 and the system processors 206 are communicably couplable via interconnects or links 204. The links 204 represents hardware (e.g., an electrical circuit) that implements connections between the clients 202 and the system processors 206. Examples of connections which are usable to implement the links 204 include but are not limited to, buses (e.g., a data bus, a system, an address bus), interconnects, memory channels, through silicon vias, traces, and planes. Other example connections include optical connections, fiber optic connections, and/or connections or links based on quantum entanglement. In one or more aspects, the links 204 include embedded logic or hardware components that enable the correct routing of data through these connections. The clients 202 provide information to the power management firmware 210 via the links 204, such as, information about types and frequency of memory accesses expected during performance of individual client workloads.

The data fabric 118 and the system processors 206 are communicably couplable via one or more interconnects or links 216. The links 216 represent variations of the types of hardware and electrical circuits used to implement the links 204 to form connections between the data fabric 118 and the system processors 206. The power management firmware 210 provides information to the data fabric 118 via the links 216, such as, information from a client records the power management firmware 210 maintains to track each of the clients 202 in the system 200 that have access to the shared last level cache 160, in addition to whether the shared last level cache 160 is presently useful to each of the clients 202.

One or more interconnects or links 218 communicably couple the data fabric 118 to the DRAM 220. The links 218 represent variations of the types of hardware and electrical circuits used to implement the links 204 and/or the links 216 to form connections between the data fabric 118 and the DRAM 220. When the shared last level cache 160 is not presently useful to the clients 202, memory accesses received from the power management firmware 210 on behalf of the clients 202 are sent through the data fabric 118 and over the links 218 to be satisfied by the DRAM 220.

The system 200 includes the linear dropout regulator 154. The linear dropout regulator 154 is a hardware component, which forms an electrical circuit that supplies power to the shared last level cache 160 by regulating voltage output from the linear dropout regulator 154 to the voltage plane 156, which powers the shared last level cache 160. The side-band connection 152 between the linear dropout regulator 154 and the data fabric 118 enables the data fabric 118 to control the level of the power supplied on the voltage plane 156 from the linear dropout regulator 154. For example, the side-band connection 152 represents a variation of the type of hardware and electrical circuits used to implement the links 158, 204, 216, and/or 218 to form a connection between the data fabric 118 and the linear dropout regulator 154.

The data fabric 118 is configured to control a level of the power supplied from the linear dropout regulator 154 to be either a normal level for enabling at least one active client to use the shared last level cache 160 or a retention level for keeping the shared last level cache 160 in a ready state when none of the active clients is currently using the shared last level cache 160. When the shared last level cache 160 is in the ready state, the cached contents, fuse settings, and other cache parameters are not accessible, however, each is maintained for immediate reuse when the shared last level cache 160 receives a normal level of power again. In one or more examples, the data fabric 118 signals the linear dropout regulator 154 over the side-band connection 152 to cause the linear dropout regulator 154 to supply power for the shared last level cache 160 to be at either a normal level or a retention level. The normal level supplied by the linear dropout regulator 154 is a first voltage level and the retention level supplied by the linear dropout regulator 154 is a second voltage level that is less than the first voltage level. For completeness, when the shared last level cache 160 is powered-off by the power management firmware 210, the linear dropout regulator 154 is also powered-off. When the shared last level cache 160 and the linear dropout regulator 154 are switched-off, the voltage plane 156 receives a lower-level voltage, which is less than the retention voltage, and in one or more examples, approximately a zero-voltage level.

When the voltage plane 156 is supplied with a normal level voltage, the shared last level cache 160 is powered-on and usable to fetch and store data for any of the clients 202. When the voltage plane 156 is supplied with a retention level voltage, the shared last level cache 160 cannot be accessed (e.g., cannot be used to fetch or store cache contents), however, the shared last level cache 160 remains initialized (e.g., fuses stay distributed), and keeps cache content and parameters preserved. The retention level voltage maintains the shared last level cache 160 in this ready state to enable quick reuse of the shared last level cache 160 and the preserved cache contents once the voltage plane 156 is resupplied with the normal level voltage. Operating in the ready state and transitioning from the ready state to the powered-on state consumes less energy and takes less time than when the shared last level cache 160 is powered-off and transitions from the powered-off state to a powered-on state. After periods of idleness, the clients 202 are able to begin using the shared last level cache 160 more efficiently than if the shared last level cache 160 continues to receive the normal power or powers-off and back-on.

To ensure that the shared last level cache 160 does not hinder, but rather improves performance and power conservation within the system 200, a power management policy is implemented by the system 200. The power management firmware 210 and the data fabric 118 implement the power management policy to allow the system 200 to carefully control when the shared last level cache 160 is powered-on, powered-off, or otherwise maintained in a power-saving retention mode during brief periods of idleness.

In furtherance of the power management policy, the power management firmware 210 turns on the shared last level cache 160 when any of the clients 202 that is active will benefit from using the shared last level cache 160. Turning on the shared last level cache 160 causes the linear dropout regulator 154 to supply the voltage plane 156 with power at the normal level sufficient to initialize the shared last level cache 160 and enable the clients 202 to use the shared last level cache 160. The shared last level cache 160 does not turn-on immediately. A latency penalty is introduced in the system 200 when the shared last level cache 160 is activated to allow sufficient time for the shared last level cache 160 to redistribute fuses and warm up the shared last level cache circuitry.

The power management firmware 210 turns off the shared last level cache 160 when none of the clients 202 is active. When the power management firmware 210 determines that shared last level cache 160 is not presently useful to any of the clients 202, the power management firmware 210 causes the system 200 to turn-off the shared last level cache 160 by deactivating the linear dropout regulator 154 and other shared last level cache circuitry. Turning off the shared last level cache 160 causes the linear dropout regulator 154 to supply the voltage plane 156 with no power. The voltage plane 156 is supplied power at a lower level (e.g., an approximately zero voltage) than the retention level. An initialization state of the shared last level cache 160 is lost when powered-off, including fuse distributions and any warming. Also, when the shared last level cache 160 is switched off, the shared last level cache controller 150 flushes the shared last level cache 160 out into the DRAM 220 to maintain coherency of a system state. With the shared last level cache 160 and the linear dropout regulator 154 powered-off, the power management firmware 210 prevents their circuit losses from wasting power from the system 200. Later, when the power management firmware 210 determines the shared last level cache 160 is possibly useful to at least one of the clients 202, the power management firmware 210 causes the system 200 to turn the shared last level cache 160 back on.

If there is at least one of the clients 202 that possibly benefits from the shared last level cache 160 being active, the power management firmware 210 does not turn-off the shared last level cache 160. However, as previously stated, keeping the shared last level cache 160 powered-on all the time to reduce latency incurred from shared last level cache reinitialization causes the system 200 to carry a heavy power penalty and wastes energy.

In furtherance of the power management policy, the data fabric 118 communicates with the power management firmware 210 to determine ways to balance latency and power consumption of the shared last level cache 160. The data fabric 118 tracks when the shared last level cache 160 is idle. During periods of idle time (i.e., when none of the active clients 202 are presently accessing their data in the shared last level cache 160), the data fabric 118 saves system power by causing the shared last level cache 160 to operate in a retention mode. In the retention mode, the data fabric 118 directs the linear dropout regulator 154 to supply a retention voltage to the shared last level cache 160. The retention voltage is less than a normal voltage supplied to the shared last level cache 160 when clients are active. The retention voltage is not sufficient to enable functionality of the shared last level cache 160 but is sufficient to maintain fuse distributions, cache content, and other parameters or initializations within the shared last level cache 160. The shared last level cache 160 is ready to be used as soon as an active client is no longer idle with respect to the shared last level cache 160. When the data fabric 118 determines that at least one of the active clients 202 being monitored by the power management firmware 210 is no longer idle and ready to begin using the shared last level cache 160 again, the data fabric 118 controls the linear dropout regulator 154 to cause the voltage plane 156 to be supplied with the normal voltage again. The shared last level cache 160 is immediately ready to be used following a transition out of retention mode because the retention voltage applied by the linear dropout regulator 154 during that time preserved the cache content and the shared last level cache initialization.

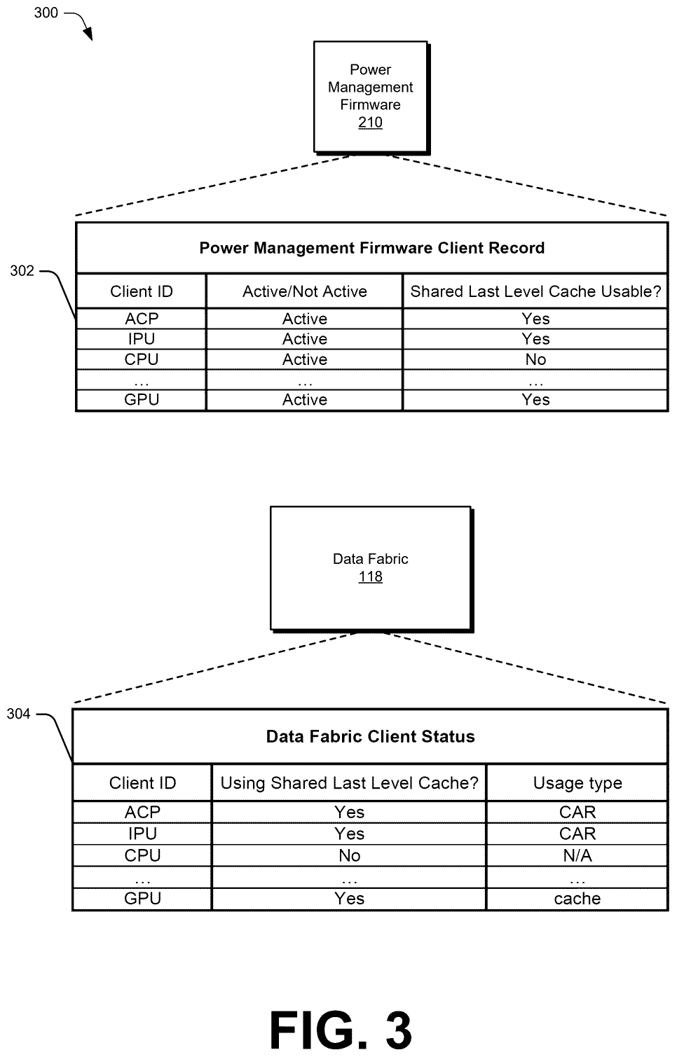

FIG. 3 depicts a non-limiting example of data records 300 maintained by components of an example system that implements shared last level cache usage management for multiple clients. As depicted in FIG. 3, the power management firmware 210 maintains a client record 302. FIG. 3 depicts one example of the client record 302, and many other variations are possible.

The client record 302 indicates each of clients 202 in the system 200 that have access to the shared last level cache 160. The power management firmware 210 uses the client record 302 to keep track of whether the shared last level cache 160 is presently useful to each client. Information from the client record 302 is shared over the links 216 with the data fabric 118. For example, the software units 208 includes drivers. Explicit messages from the drivers are received by the power management firmware 210 when the software units 208 want to use the shared last level cache 160. The software units 208 are aware of their memory access patterns and share them with the power management firmware 210 to determine whether the shared last level cache 160 is presently useful or not.

Within the client record 302, the power management firmware 210 includes a table with each row corresponding to a different one of the clients 202. A first column includes a client ID corresponding to one of the clients 202. A second column includes an indication of whether that client is active or not. Finally, a third column indicates whether the shared last level cache 160 is usable by that client. In this example, each of the clients 202 is active, however only the CPU 202-3 is listed as not usable with the shared last level cache 160. In this example, the power management firmware 210 maintains the shared last level cache 160 in a powered-on state. If, however, each of the clients designated as possible users of the shared last level cache 160 becomes inactive, the power management firmware 210 powers-off the shared last level cache 160 to conserve energy. Even if only one of the clients 202 is an active candidate for using the shared last level cache 160, the power management firmware will not power down the shared last level cache 160.

As further depicted in FIG. 3, the data fabric 118 maintains a status record 304. FIG. 3 depicts one example of the status record 304, and many other variations are possible. The status record 304 indicates each of the clients 202 in the system 200 that are active. The data fabric 118 uses the status record 304 to keep track of whether the shared last level cache 160 is being used by an active client and if so, how the shared last level cache 160 is being used (e.g., either as a standard cache or CAR). Information from the status record 304 indicates to the data fabric 118 whether the shared last level cache 160 is to enter a retention mode or not. For example, using hints received from the software units 208 and/or the power management firmware 210, the data fabric 118 estimates whether an idle period experienced with one of the active clients 202 is long enough to warrant placing the system 200 in the retention mode. If the idle period is sufficient, the data fabric 118 determines the active client to be idle.

Within the status record 304, the data fabric 118 includes a table with each row corresponding to a different one of the clients 202 that the power management firmware 210 indicates as being active. A first column includes a client ID corresponding to one of the clients 202. A second column includes an indication of whether that client is using the shared last level cache 160. Finally, a third column indicates how the shared last level cache 160 is being used. In this example, each of the clients 202 is active, however only the CPU 202-3 is listed as not using the shared last level cache 160. In this example, the data fabric 118 maintains the shared last level cache 160 in a powered-on state. If, however, each of the clients 202 designated as actual users of the shared last level cache 160 become idle, the data fabric 118 causes the linear dropout regulator 154 to conserve energy by powering the shared last level cache 160 in a retention mode. While in the retention mode, fuse distributions, cache content, and other initialization conditions are preserved. This way, when any of the clients 202 designated as actual users of the shared last level cache 160 is no longer idle and begins using the shared last level cache 160 again, the shared last level cache 160 can be returned to the normal, powered-on mode with less latency than had the shared last level cache 160 been completely powered-off.

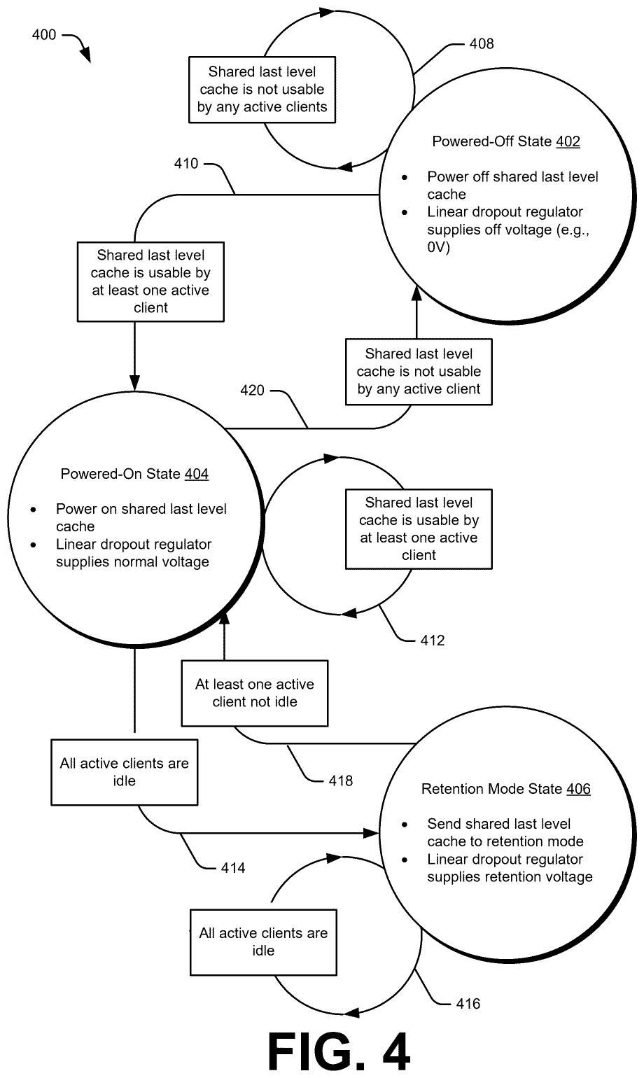

FIG. 4 depicts a state diagram 400 of different operating states of a non-limiting example system that implements shared last level cache usage management for multiple clients. FIG. 4 depicts how the systems 100 and 200 are configured to operate in at least three different states. Although FIG. 4 depicts three different operating states 402, 404, and 406, additional operating states are used in other implementations.

A powered-off state 402 reflects when the shared last level cache 160 is powered-off when none of the clients 202 is active, or when the shared last level cache 160 is not usable to any of the clients 202 that is active. During this first state, the power management firmware 210 causes the shared last level cache 160 to be powered-off. In the powered-off state 402, the power management firmware 210 causes the system 200 to power-off the linear dropout regulator 154 such that a lower voltage (e.g., a zero voltage) is supplied to the voltage plane 156.

A powered-on state 404 reflects when the shared last level cache 160 is fully functional and facilitating memory accesses by at least one of the clients 202. The system 200 transitions from the powered-off state 402 to the powered-on state 404 when the shared last level cache 160 is presently useful to at least one of the clients 202 that becomes active. During this second state, the power management firmware 210 causes the shared last level cache 160 to be powered-on. In the powered-on state 404, the power management firmware 210 causes the system 200 to power on the linear dropout regulator 154 such that a normal voltage is supplied to the voltage plane 156.

A retention mode state 406 reflects when the shared last level cache 160 is presently useful to at least one of the clients 202 that is active, however, that client is idle (e.g., not currently performing tasks to access the shared last level cache 160). The system 200 transitions from the powered-on state 404 to the retention mode state 406 during an idle period experienced by the data fabric 118, which is when the clients 202, although active, are not using the shared last level cache 160. In one or more implementations, the data fabric 118 waits to determine whether idleness has occurred or will occur for a long enough period that makes operating the shared last level cache 160 in the retention mode worthwhile.

During this third state, the data fabric 118 causes the shared last level cache 160 to operate in retention mode where, based on the power supplied for the shared last level cache 160 at the retention level, the shared last level cache 160 remains initialized to be ready to handle future accesses upon later transitioning the system 200 back to the second state. In the retention mode state 406, the data fabric 118 controls the linear dropout regulator 154 using the side-band connection 152 to cause the linear dropout regulator 154 to supply power for the shared last level cache 160 at a retention level.

When the system 100 or 200 enters the retention mode state 406, the shared last level cache controller 150 causes content of the shared last level cache 160 to be maintained, along with initialization settings for the shared last level cache 160 (e.g., fuse distributions), so the shared last level cache 160 is ready to quickly resume operations after a warmup if the system 200 returns to the powered-on state 404. After transitioning to the retention mode state 406, the retention voltage out of the linear dropout regulator 154 enables the shared last level cache 160 to maintain cache content and fuse distributions previously established for the shared last level cache 160 during the powered-on state 404.

The state diagram 400 includes several transitions linking the states 402, 404, and 406. A transition 408 is provided to indicate that when the shared last level cache 160 remains unusable to any of the clients 202 that are active, the system remains in the powered-off state 402. A transition 410 out of the powered-off state 402 indicates the system 200 transitioning to the powered-on state 404 when the shared last level cache 160 is usable by at least one of the clients 202 that is active.

A transition 412 is provided to convey that when the shared last level cache 160 remains usable to at least one of the clients 202 that is active, the system remains in the powered-on state 404. A transition 414 out of the powered-on state 404 indicates the system 200 transitioning to the retention mode state 406 when, despite the shared last level cache 160 being usable by at least one of the clients 202 that is active, that client is idle and not presently executing instructions to access the shared last level cache 160.

A transition 416 is shown in FIG. 4 for conveying that when each of the clients 202 that is active is idle with respect to the shared last level cache 160, the system 200 remains in the retention mode state 406. A transition 418 out of the retention mode state 406 indicates the system 200 transitioning back to the powered-on state 404 when at least one of the clients 202 that is active is no longer idle with respect to the shared last level cache 160.

The system 200 transitions from any of the other states into the powered-off state 402 when none of the clients 202 is active. For example, a transition 420 out of the powered-on state 404 indicates the system 200 transitioning to the powered-off state 402 when, the shared last level cache 160 is no longer usable to any of the clients 202 or none of the clients 202 is active.

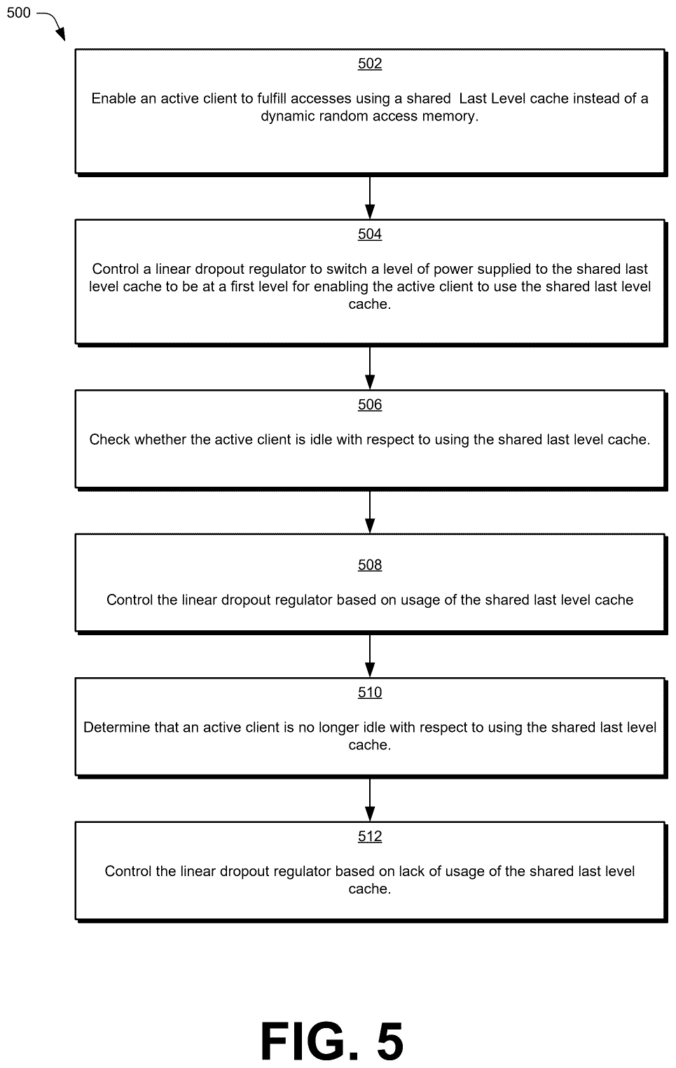

FIG. 5 depicts a procedure 500 for performing shared last level cache usage management for multiple clients. Steps or operations of the procedure 500 are depicted as blocks 502 through 512. In one or more examples, the procedure 500 includes additional or fewer steps than those depicted. In various implementations, the steps of the procedure 500 are implemented in a different order than the order illustrated in FIG. 5.

An active client is enabled to fulfill accesses using a shared last level cache instead of a dynamic random access memory (block 502). For example, the data fabric 118 maintains the status record 304 and performs a lookup to determine whether any of the active clients in the status record 304 are using the shared last level cache 160 or not. In one or more aspects, the power management firmware 210 executes on the processors 206 to identify a workload of one of the active clients 202 that benefits from accessing the shared last level cache 160 instead of the DRAM 220. The client record 302 is updated by the power management firmware 210 to reflect any benefit to an active client using the shared last level cache 160. For example, the software units 208 includes drivers. Explicit messages from the drivers are received by the power management firmware 210 when the software units 208 wants to use the shared last level cache 160. The software units 208 are aware of their memory access patterns and share them with the power management firmware 210 to determine whether the shared last level cache 160 is presently useful or not.

For example, the IPU 202-2 recognizes its access pattern and whether conjugative accesses or contiguous accesses are occurring. When conjugative, the accesses are bursty and frequently evicted into the DRAM 220. If contiguous, accesses are more likely to be resident in the shared last level cache 160 and not likely to be evicted into the DRAM 220. The power management firmware 210 infers from this information whether forwarding a memory request to the DRAM 220 or forwarding the memory request to the shared last level cache 160 is more beneficial. The power management firmware 210 communicates to the data fabric 118 whether a client is active and whether the shared last level cache 160 is usable, which causes the data fabric 118 to enable the active client to fulfill accesses using the shared last level cache 160.

A linear dropout regulator is controlled to switch a level of power supplied to the shared last level cache to be at a first level for enabling the active client to use the shared last level cache (block 504). In response to identifying at least one active client that is using the shared last level cache 160, the data fabric 118 ensures the linear dropout regulator 154 continues to supply the normal voltage to the voltage plane 156.

Whether the active client is idle with respect to using the shared last level cache is checked (block 506). For example, using hints received from the software units 208 and/or the power management firmware 210, the data fabric 118 estimates whether an idle period experienced with one of the active clients 202 is long enough to warrant placing the system 200 in the retention mode state 406. If the idle period is sufficient, the data fabric 118 determines the active client to be idle.

The linear dropout regulator is controlled based on usage of the shared last level cache (block 508). For example, the linear dropout regulator is controlled to switch the level of power to be at a second level for keeping the shared last level cache in a ready state to handle future accesses of the active client when the active client is no longer idle with respect to using the shared last level cache. In response to determining the active clients are sufficiently idle to warrant placing the shared last level cache 160 in retention mode, the data fabric 118 controls the linear dropout regulator 154 to supply the retention voltage to the voltage plane 156. In one or more aspects, when the data fabric 118 controls the linear dropout regulator 154 to switch the level of power of the voltage plane 156 to be at the retention level, the data fabric 118 controls the linear dropout regulator 154 for maintaining cache content and fuse distributions previously established for the shared last level cache 160. In one or more implementations, to control the linear dropout regulator 154 to provide the retention voltage, the data fabric 118 signals the linear dropout regulator 154 over the side-band connection 152 to supply power at the retention level.

The procedure 500 continues by determining that an active client is no longer idle with respect to using the shared last level cache (block 510). For example, the data fabric 118 determines when an active client 202 is about to or has requested access to the shared last level cache 160 and initiates a transition back to the powered-on state 404.

The linear dropout regulator is controlled based on lack of usage of the shared last level cache (block 512). For example, the linear dropout regulator is controlled to switch the level of power to be at the first level for enabling the active client to reuse the shared last level cache. To exit the retention mode state 406, the data fabric 118 sends a signal to the linear dropout regulator 154 over the side-band connection 152, for instance, to supply power at the normal level again. Because the shared last level cache 160 is kept in retention mode during periods of idle, performance of the system 200 is maintained. The system 200 does not have to wait until the shared last level cache 160 is reinitialized because its cache content and parameters (e.g., fuse distributions) are preserved by the retention voltage applied to the voltage plane 156.

In one or more aspects, the power management firmware 210 controls the linear dropout regulator 154 to switch the level of the power supplied to the shared last level cache 160 to be at a lower level than the retention level to power off the shared last level cache 160 when no active clients are available to use the shared last level cache 160. For example, whether the system 200 is operating in the powered-on state 404 or the retention mode state 406, the PMFM causes the system 200 to pull power from the shared last level cache 160 and the linear dropout regulator 154 to conserve energy because none of the clients 202 is active and/or the shared last level cache 160 is not likely to be used.

In one or more aspects, the power management firmware 210 controls the linear dropout regulator 154 to switch the level of the power supplied to the shared last level cache 160 to transition from the lower level to the normal level for enabling the active client to use the shared last level cache 160. For example, when the system 200 is operating in the powered-off state 402, the PMFM causes the system 200 to apply normal power to the shared last level cache 160 and the linear dropout regulator 154 to enable use of the shared last level cache 160.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (e.g., the CPU 102, the data fabric 118, the clients 202, the system processors 206, the shared last level cache controller 150, the shared last level cache 160, the software units 208, the power management firmware 210) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a CPU, a Digital Signal Processor (DSP), a GPU, a parallel accelerated processor, a plurality of microprocessors, one or more microprocessors in association with a DSP core, a controller, a microcontroller, an Application Specific Integrated Circuit (ASIC), a Field Programmable Gate Array (FPGA) circuit, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read-only memory (ROM), a random-access memory (RAM), a register, cache memory, semiconductor memory devices, magnetic media such as internal hard disks and removable disks, magneto-optical media, and optical media such as a CD-ROM disk, or a digital versatile disk (DVD).

What is claimed is:

1. A system comprising:
a shared last level cache coupled to multiple clients and a dynamic random access memory;
a linear dropout regulator that supplies power to the shared last level cache; and
a data fabric that controls a level of the power supplied from the linear dropout regulator based on usage of the shared last level cache.

2. The system of claim 1, wherein the data fabric is configured to control the level of the power supplied from the linear dropout regulator to be either a first level that enables at least one active client to use the shared last level cache or a second level to keep the shared last level cache in a ready state when the at least one active client does not use the shared last level cache.

3. The system of claim 2, further comprising:
a side-band connection between the linear dropout regulator and the data fabric, wherein the data fabric controls the level of the power supplied from the linear dropout regulator by sending a signal over the side-band connection to cause the linear dropout regulator to supply power for the shared last level cache at either the first level or the second level.

4. The system of claim 2, wherein the first level comprises a normal voltage level and the second level comprises a retention voltage level that is less than the normal voltage level.

5. The system of claim 2, further comprising:
at least one processor configured to execute power management firmware that:
turns the linear dropout regulator on to supply the power at the first level to initialize the shared last level cache and enable the at least one active client to use the shared last level cache; and
turns the linear dropout regulator off to supply the power at a third level that is lower than the second level when none of the multiple clients is active.

6. The system of claim 5, wherein the third level comprises an approximately zero-voltage level.

7. The system of claim 5, wherein the system is configured to operate in at least three different states, wherein:
during a first state, the power management firmware causes the shared last level cache to be powered-off;
during a second state, the power management firmware causes the shared last level cache to be powered-on; and
during a third state, the data fabric causes the shared last level cache to operate in retention mode where, based on the power supplied for the shared last level cache at the second level, the shared last level cache remains initialized to be ready to handle future accesses upon later transitioning back to the second state.

8. The system of claim 7, wherein the system transitions from the first state to the second state when at least one of the multiple clients becomes active.

9. The system of claim 8, wherein the system transitions from the second state to the third state during an idle period of the data fabric when the at least one active client is not using the shared last level cache.

10. The system of claim 9, wherein after transitioning to the third state the shared last level cache maintains cache content stored in the shared last level cache during the second state.

11. The system of claim 9, wherein after transitioning to the third state the shared last level cache maintains fuse distributions previously established for the shared last level cache during the second state.

12. The system of claim 7, wherein when none of the multiple clients is active the system transitions from the second state to the first state or from the third state to the second state to the third state.

13. The system of claim 1, wherein the multiple clients include a central processing unit, wherein the system further comprises a main cache internal to the central processing unit, and the shared last level cache is coupled to the main cache and the dynamic random access memory.

14. A data fabric comprising hardware components configured to:
switch a level of power supplied to a shared last level cache to be at a first level that enables multiple active clients to use the shared last level cache;
switch the level of power to be at a second level that keeps the shared last level cache in a ready state when each of the active clients is idle with respect to use of the shared last level cache; and
switch the level of power to be at the first level when at least one of the active clients is no longer idle with respect to use of the shared last level cache.

15. A method comprising:
enabling, by a data fabric of a system, an active client to fulfill accesses using a shared last level cache instead of a dynamic random access memory;
controlling, by the data fabric, a linear dropout regulator to switch a level of power supplied to the shared last level cache to be at a first level;
based on the active client being idle with respect to use of the shared last level cache; and
controlling, by the data fabric, the linear dropout regulator to switch the level of power to be at a second level when the active client is no longer idle with respect to use of the shared last level cache.

16. The method of claim 15, further comprising:
executing, by a processor of the system, power management firmware to identify a workload of the active client that benefits from access to the shared last level cache instead of the dynamic random access memory; and
communicating the active client to the data fabric to cause the data fabric to enable the active client to fulfill accesses at the shared last level cache.

17. The method of claim 16, further comprising:
controlling, via the power management firmware, the linear dropout regulator to switch the level of the power supplied to the shared last level cache to be at a third level that is lower than the second level to power off the shared last level cache when no active clients are available to use the shared last level cache; and
controlling, via the power management firmware, the linear dropout regulator to switch the level of the power supplied to the shared last level cache to transition from the third level to the first level for enabling the active client to use the shared last level cache.

18. The method of claim 15, wherein controlling the linear dropout regulator by the data fabric comprises:
sending, by the data fabric, a signal over a side-band connection between the linear dropout regulator and the data fabric, whether the linear dropout regulator is to supply power at the first level or the second level.

19. The method of claim 15, wherein controlling the linear dropout regulator to switch the level of power to be at the second level comprises maintaining cache content in the shared last level cache.

20. The method of claim 19, further comprising:
controlling, by the data fabric, the linear dropout regulator to switch the level of power to be at the second level for maintaining the cache content and fuse distributions previously established for the shared last level cache.
